(19) United States
(12) Patent Application Publication
(10) Pub. No.: US 2010/0162327 A1
(43) Pub. Date: Jun. 24, 2010

(54) In-Flight Entertainment System

(75) Inventor: Terence Bonar, Dunlaoighre (IE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Airvod Limited, Dublin (IE)

(21) Appl. No.: 12/338,891

(22) Filed: Dec. 18, 2008

(51) Int. Cl. H04N 7/18

(52) U.S. Cl. 725/77

(57) ABSTRACT

An in-flight entertainment system is described. The system includes a plurality if media players that are installed at fixed locations within an aircraft cabin. Individual media players are provided with a dedicated media data storage device physically coupled to the media player such that a playing of specific media requires local access to that media content.

### FIELD OF THE INVENTION

The present invention relates to entertainment systems that are provided for in-flight use so that passengers can avail of audio and or audio/visual entertainment during the duration of the flight.

### BACKGROUND

In flight entertainment systems are well known. Traditionally these systems were provided in the form of a central distribution hub within the aircraft which provided audio visual feeds to a plurality of screens within the cabin. The cabin attendant would initiate the playing of a particular movie and all passengers within a designated cabin area would be able to watch that movie through shared screens.

With developments in technology it became possible to deliver individual screens to each seat within the cabin. It is known to provide this in one of two forms; firstly where the person at the seat has no choice in determining the viewing schedule and secondly where the person at the seat can individualise their viewing program. Despite the differences in the personalisation of the audio visual at the seat, the content is still delivered from a central hub within the cabin to each seat. This requires complex wiring systems to ensure that the data can be fed at adequate speeds to ensure quality of service to each viewer. With multiple programming available this requires high quality cabling to be used within the cabin. The cabling requirements for large aircraft can be of the order of 0.5 to 1.5 tonnes. In today's market place where fuel costs are a major proportion of flight costs these weights contribute significantly to the cost of the flight.

It is also known to provide standalone personalised media players for a user to place on a tray top table or on the user's lap. These typically are provided with a battery and a hard drive which has the media content stored thereon. As aircraft regulations require stowing of such handheld devices during takeoff and landing, these need to be taken from each passenger during these times by members of the cabin crew and stored separately. This has two disadvantages in that cabin crew time is taken up in distributing and recovering these personalised media players and also that there is a space requirement within the cabin for the centralised storage of the players. Another problem with such devices is that the displayed content is not dynamic—it is unrelated to the flight being taken and is simply a playing of the stored content on demand by the user. They cannot as such provide information such a flight location as is available from the traditional centralised hub based arrangement where the information is centrally relayed to the seat displays.

Another problem associated with conventional in-flight entertainment systems is that often people wish to recharge or power their own personal electronic equipment during the flight. This has been catered for by providing power outlets at the individual seats where a user can couple for example a USB power connector between the power outlet and their personal electronic equipment. However, a problem with this is that the available power traditionally available on-board aircraft is not sufficient to provide each passenger concurrently with power. This has to date resulted in some airlines restricting the power outlets to certain seat categories. Where power outlets are provided throughout the cabin it is known that if a predefined number of concurrent users is exceeded that any subsequent user will not be able to access power. This can create problems.

There are therefore a number of problems associated with existing in-flight entertainment systems.

### SUMMARY

These and other problems are addressed by an in-flight entertainment provided in accordance with the present teaching. Such a system provides a plurality of media players which are distributed about the cabin to enable one or more passengers view selected media content. In a first arrangement, the storage of that media content is provided at the point of delivery of that media content. This storage may be provided in the form of a hard drive or other memory device that may be coupled to the media player. Desirably each passenger seat is provided with an integrated media player. This integrated media player is desirably either located immediately to the front of the passenger, such as for example within the back of the seat immediately in front of that passenger, within a bulkhead partition in front of a row of seats adjacent the bulkhead partition or as part of the arm rest for particular seats.

The memory device may be removable and can be taken from media player for an update of the media content stored thereon. Desirably the memory device is lockable within the media player such that any inadvertent removal of the memory device is minimised. Typically each media player will have an associated memory device removal tool that on interface with the media player will enable a removal of the memory device from the media player.

In accordance with another embodiment a media player chassis is provided. Such a chassis may be integrated into a passenger seat and is dimensioned to receive a media player therein. Receipt of the media player into the chassis is desirably effected through a locking inter-engagement such that removal of the media player from the chassis requires a separate tool to disengage the locking and allow removal of the media player from the chassis.

The chassis may include a chassis power connector which is provided such that on inter-engagement of the media player with the chassis, that a corresponding power connector on the media player will couple with the chassis power connector to effect a delivery of power to the media player. The media player may have a secondary power connector that is provided on an accessible external surface of the media player to enable a user to power one or more secondary devices from the chassis power connector.

The chassis power connector is desirably coupled to a seat power box which is provided locally and configured to provide power to a plurality of adjacent of seats. The seat power box is typically coupled to a cabin power supply feed. Such a cabin power supply feed typically comprises a plurality of supply lines, only a portion of which are used for providing actual power. Within such a loom or bundle there are redundant lines. In accordance with an embodiment of the present invention the power supply line bundle that defines the power supply line feed is used to convey signals to the individual media players from a central location within the cabin. The actual lines within the loom that are used as the signal conduit may be selected from the power lines in which case appropriate filters may be required to piggyback data communication on the power line. In an another arrangement redundant or discrete lines within the loom that are not normally used for conveying the power within the cabin are used as signal conduits for transporting signals to individual media players within the cabin.

In another arrangement power to individual media players is directly controllable such that power provided at any one of a number of different locations can be controlled. Desirably the power will be controlled through a switch which is activated through user interaction at the media player. Desirably such user interaction will effect generation of a control signal that may be used to activate a normally inactive switch. Typically the switch will be provided locally to the media player. Such a switch could be integrally provided within a seat power box or could be provided in the electric circuit between the seat box and the power outlet of the individual seat. By enabling control of the available power at a particular seat from that seat it is possible for the passenger at that seat to activate the power without recourse to the cabin staff.

In a further arrangement an in-flight entertainment system is provided which effects control of features of a plurality of media players that are distributed throughout an aircraft cabin through a transmission of control signals from a central hub within the cabin to the individual media players. This central hub or location could be a cabin interface module accessible for example by flight crew or attendants or could be a central server element of the in-flight entertainment system. In either arrangement the command signals are distributed from a central location within the cabin to a plurality of media players. Where the command signals originate from a cabin interface module they could be routed through server elements of the in-flight entertainment system prior to receipt at the individual media players or they could be provided in a direct communication from the cabin interface module. Signals from this central location may be used to synchronise or coordinate the display of specific content at specific ones of the plurality of media players.

Such control signals could be provided as wireless control signals in that they are transmitted through one or more wireless communication protocols within the aircraft cabin.

In another arrangement the control signals are transmitted over the power line bundle that is provided within the aircraft cabin. The bundles typically terminate at each seat within the aircraft and as was mentioned above are conventionally used for providing power at the seat. By using such a power bundle to provide commands to individual media player, a system in accordance with the present teaching obviates the need for dedicated data lines coupling each media player. This data is desirably pushed to the media players from the central hub within the aircraft. The data can be unique data which is generated specifically for that transmission or could be predefined command signals which are stored within a library within the central hub and distributed to the media players as appropriate. On receipt of a predefined command signal the media player will effect a retrieval of a predefined media file and effect a local playing of that for the user.

The use of command signals that are centrally transmitted to a plurality of media players whereupon local retrieval of specific datafiles is effected may be advantageously employed to provide higher detail information to passengers than heretofore possible. For example, traditionally in a moving map display all information is transmitted from the central hub to the point of display. This requires the concurrent transmission within the aircraft of graphic files, geographic location and the like. By separating out the imagery of the graphic files from the real time information of the geographic location, it is possible to provide higher detail information in the graphic files.

The command signals may also be used to effect simultaneous generation of language specific safety demonstrations. It will be appreciated that traditionally an aircraft records and displays the required safety demonstrations in a first language—that being the language of the aircraft carrier. By providing localised storage of the data files relevant to the safety demonstrations at the point of display, it is possible to provide additional features such as subtitles in different languages or indeed the provision of different language audio files for the same graphic files. By using command signals that are centrally distributed the synchronisation between the image and the audio/subtitle can be controlled.

These and other features will be better understood with reference to the following which are provided to assist in an understanding of the teaching of the benefits derived from the present invention but are not to be construed as limiting in any fashion.

### BRIEF DESCRIPTION OF THE DRAWINGS

The present invention will now be described with reference to the accompanying drawings in which:

FIG. 1 is a schematic showing installation of an inflight entertainment system in accordance with the teaching of the present invention.

FIG. 2 is a schematic showing how a media player may be interfaced with a seat back.

FIG. 3 shows seat back with a fully inserted media player.

FIG. 4 shows how the viewing angle of the media player may be modified.

FIG. 5 shows how a template may be used in cases where a media player is not seated within a recess formed in a head rest of a seat.

FIG. 6 shows an exploded view of a media player having a removable data storage unit.

FIG. 7 shows a rear view of an assembled device from FIG. 6.

FIG. 8 shows a mounting of a media player to a seat arm.

FIG. 9 shows in schematic form a network architecture for an in-flight entertainment system in accordance with the present teaching.

FIG. 10 shows in schematic form how a plurality of media players provided in accordance with the present teaching may by coupled to a power box adjacently located to the individual seats.

FIG. 11 shows how power for individual seats may be controlled at the seat in accordance with the teaching of the present invention.

### DETAILED DESCRIPTION OF THE DRAWINGS

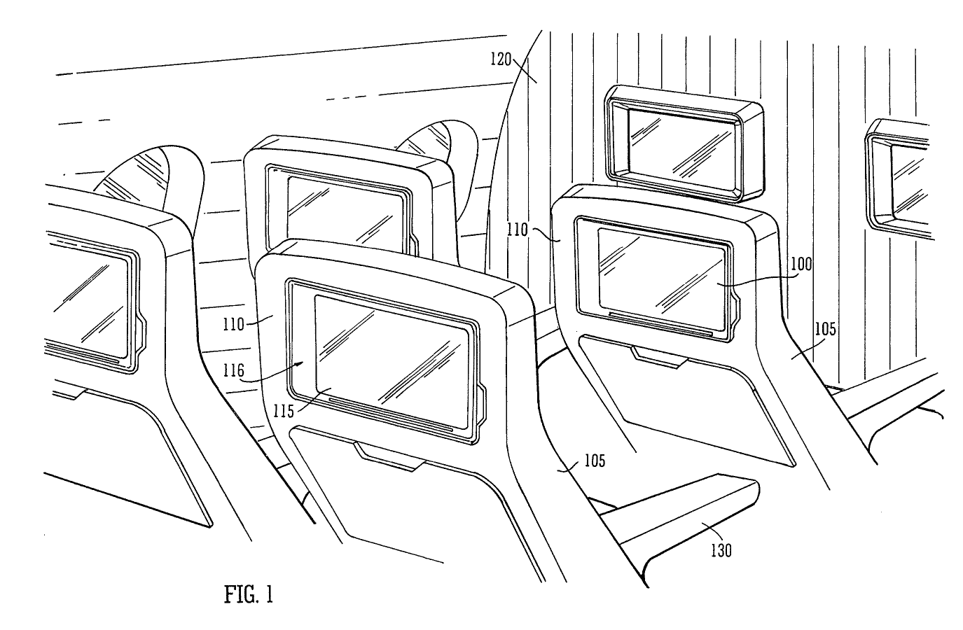

Exemplary arrangements of in-flight entertainment systems provided in accordance with the present teaching will now be described with reference to FIGS. 1 to 11 of the accompanying drawings. Such a system provides a plurality of media players 100 which are distributed about the cabin to enable passengers view selected media content. In the arrangement of FIG. 1 each passenger seated within a seat 105 is provided with their own media player 100 such that the passenger can individually tailor their entertainment to their personal preference, at a time and duration of their choosing. To facilitate the individualisation and on-demand provision of media, desirably each passenger seat 105 is provided with an integrated media player. As shown in FIG. 1, this integrated media player 100 is desirably either located immediately to the front of the passenger, such as for example within a back 110 of the seat immediately in front of that passenger or within a bulkhead partition 120 in front of a row of seats 125 adjacent the bulkhead partition. In a further modification, such as shown in FIG. 8, the media player could be provided as part of an extendible arm located on an arm rest 130 of a passenger’ seat. Each of the media players include a screen 115 provided on a front surface 116 of the media player. It will be appreciated that different cabin arrangements will differ in the exact deployment of the media players within the cabin and it is not intended to limit the present teaching to any one specific arrangement.

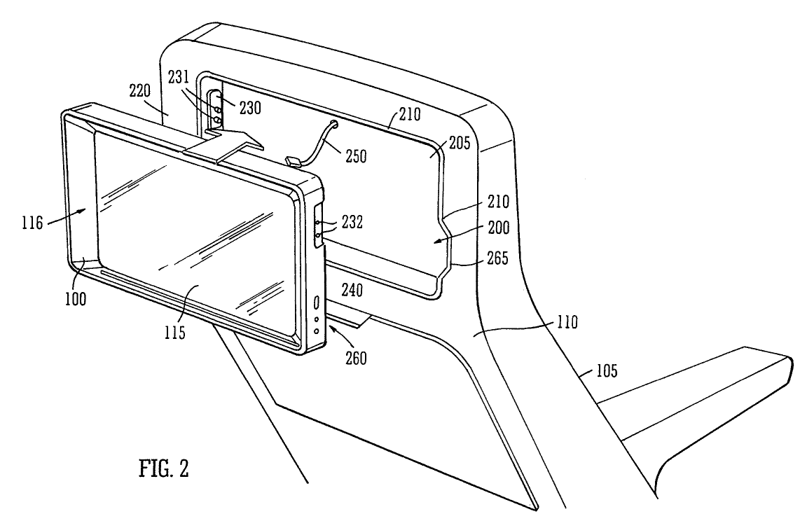

In a first arrangement, the media player 100 is provided separate to the seat and can be removed from the seat or bulkhead where it is mounted. To enable this mounting a media player chassis 200, such as that shown in FIG. 2, may be integrated into a passenger seat. The chassis 200 is dimensioned to receive a media player 100 therein. In the arrangement of FIG. 2, the chassis 200 is provided within a recess formed within the back 110 of a seat 105. This recess will desirably be fabricated or formed within the seat back at the time of manufacture of the seat. The recess includes a planar surface 205 with a plurality of side walls 210 defining a perimeter of the chassis 200. The chassis is desirably inserted into the recess such that the planar surface 205 is substantially parallel with a head rest portion 220 of the back 110 of the seat 105. Once inserted into the recess the planar surface 205 is distally located from the mouth of the recess. The side walls 210 which orientated to be substantially perpendicular with the planar surface 205 extend from the mouth of the recess inwardly towards the planar surface. The height of the side walls 210 defines the depth at which the chassis 200 will be received into the head rest portion 220. Desirably this height is also comparable with the depth of the media player such that once received within its chassis, the screen 115 will be flush with the back of the head rest portion 220.

The chassis is provided with at least one docking point 230 including a locking means 231 that is mateable with corresponding locking means 232 provided on a side wall 240 of the media player. In this exemplary arrangement two pins 231 are provided on each docking point 230 of the chassis and these are receivable into apertures 232 provided in the side walls of the media player. As shown in FIG. 2 the media player is slideable into the chassis. Receipt of the media player 100 into the chassis 200 desirably results in a locking inter-engagement between each of the locking means such that removal of the media player from the chassis requires a separate tool to disengage the locking and allow removal of the media player from the chassis. The inter-engagement could be secured in any one of a number of different fashions. For example the pins could be spring loaded and insertion of the locking tool would effect a compression of the springs to allow the pins to disengage from the apertures of the media player to allow it to be removed. On receipt within the chassis, each of the side walls of the media player are desirably co-planar with corresponding side walls of the chassis.

The chassis may include a chassis power connector 250 which is provided such that on inter-engagement of the media player with the chassis, that a corresponding power connector on the media player may be coupled with the chassis power connector to effect a delivery of power to the media player 100. The media player may have a secondary power connector 260 that is provided on an accessible external surface of the media player to enable a user to power one or more secondary devices from the chassis power connector. In the arrangement of FIG. 2, this secondary power connector 260 is provided on a side wall 240 of the media player. To allow for access to that connector when the media player is received within the chassis, the side wall 210 of the chassis that will be coincident with the secondary power connector is provided with a notch 265 or recess. In this way on insertion into the chassis that portion 260 of the side wall 210 is accessible to a user who can then couple recharging devices or the like into the available power supply 260. As opposed to litter the front surface of the media player with additional interface ports or the like, that secondary power connector region may also provide audio output jacks or the like whereby a user can connect headphones to avail of the audio content of the media player.

The chassis power connector is desirably coupled to a seat power box which is provided locally and configured to provide power to a plurality of adjacent of seats. Examples of such seat boxes include those provided by the Astronics Corporation under the registered trade mark EmPower®. These seat boxes are conventionally coupled to power line bundles that are provided within the aircraft cabin and are used for providing power at each seat. These bundles conventionally comprise a plurality of lines, only a portion of which are used for carrying power.

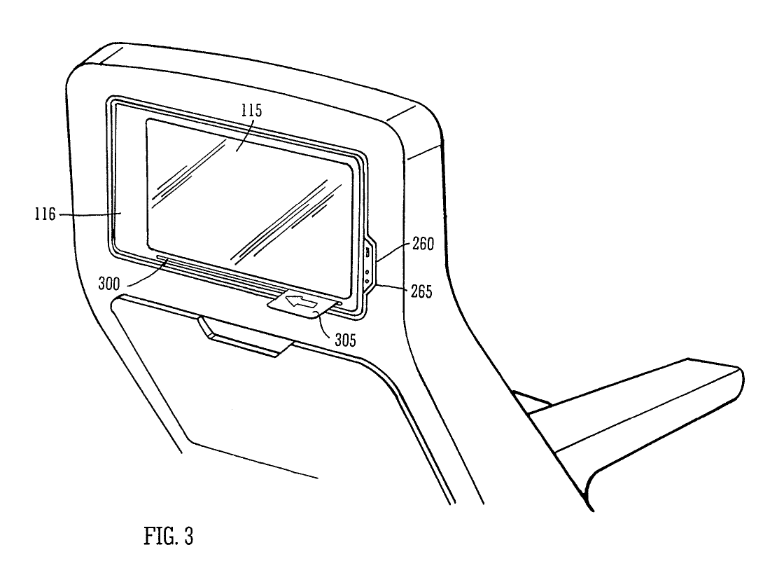

FIG. 3 shows a fully inserted media player received within its corresponding chassis. The benefit of the notch 265 is evident in that unrestricted access to the secondary power supply or other interface ports 260 is provided yet the screen is substantially flush with the back of the head rest. While it is considered that much of the media that will be available to a passenger will be free to view, it is possible to also include a charge element for all or some of the content. To enable charging for that content, a credit or debit card interface 300 is provided on the front face 116 of the media player. In the exemplary arrangement of FIG. 3 this is provided as a swipe whereby a passenger will swipe their credit card 305 in a direction perpendicular to the plane of the display screen 115 to enable a reading of the information stored on the magnetic stripe of the card. It will be appreciated that such an arrangement is illustrative of the type of payment means that may be employed within the context of the teaching of the present invention.

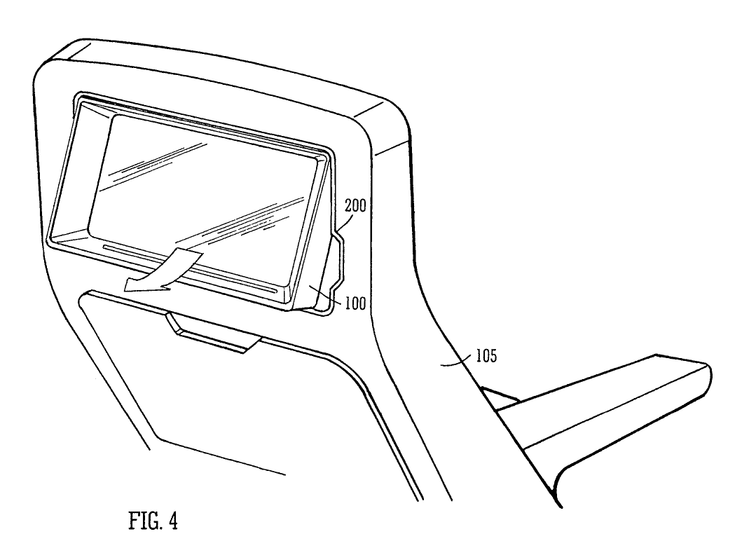

While it is desirable that once received within its chassis that the media player will be held in place, it is possible to provide for a pivot mounting arrangement whereby while the chassis provides for retention of the media player relative to components of the aircraft, that the media player once mated with the chassis is pivotable relative thereto so as to allow the user to change the angle of viewing. FIG. 4 shows an example of such an arrangement wherein a lower portion of the media player can be tilted upwardly relative to the head rest of the seat. This is particularly advantageous in circumstances where the seat in front of the passenger watching the media content on the media player (the media viewer) has been tilted back—for example if the person in front wishes to recline—and the media viewer finds their viewing angle changed. By tilting the media player 100 upwardly in the direction shown, it is possible to compensate for the reclining of the seat in front.

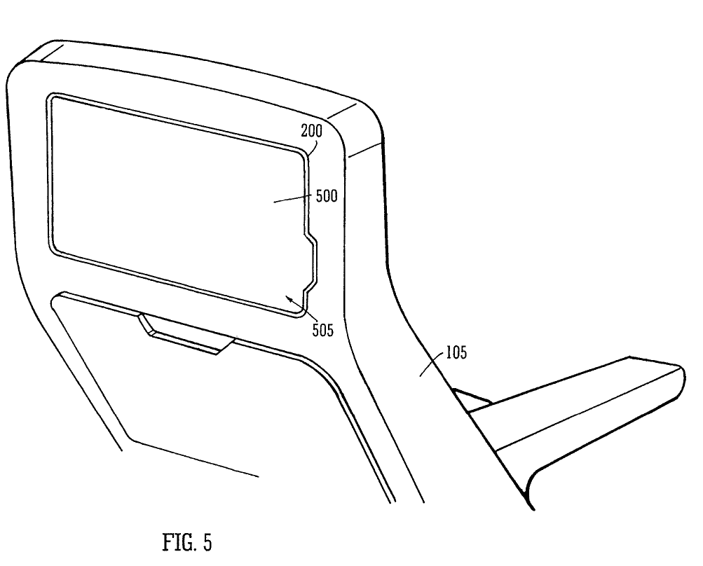

While it is desirable that each seat be provided with its own media player it is possible that certain configurations may be provided with no media player. As was discussed above, the recess formed in the seat head rest is desirably provided at the time of manufacture. In this context it is not aesthetically pleasing to provide such recesses in a visible fashion. To compensate for such circumstances—which may for example arise during the maintenance of a particular media player—a dummy panel 500, such as that shown in FIG. 5 may be provided. This dummy panel 500 is dimensioned to resemble a media player similarly to same is receivable within the chassis. Once received a front surface 505 of the dummy panel is flush with the back of the head rest, thereby maintaining the streamlined form.

Heretofore the media player has been described with reference to the removable device that may be attached or coupled to elements of the aircraft cabin such as the chair or bulkhead. Such a device is advantageous in that it may be easily removed or replaced for maintenance purposes without requiring major disassembly of the furniture provided within the aircraft cabin. As the media player is attached to the furniture during normal operation it does not require the provision of separate storage areas within the cabin during take off and landing.

Furthermore the provision of media content to a removable media player such as that described thus far has not been discussed. It is possible to couple the media player to conventional data feeds such as are provided in existing air craft. Such data feeds are capable of transmitting data from a centralised data source within the cabin to each of a plurality of individual media devices. Depending on the configuration of the entertainment system, the passenger can either select a personalised viewing schedule or can be presented with a fixed viewing sequence of media items.

In a modification to this conventional arrangement the media devices described herein may be configured to incorporate a dedicated media storage device such that each media device will have its independent source of media content. In this way the requirement to couple the individual media players back to a centralised data source within the cabin is obviated. In this way the storage of media content for that media player is provided at the point of delivery of that media content. This storage may be provided in the form of a hard drive or other memory device that may be coupled to the media player. The memory device may be provided as a removable entity such that it can be taken from the media player for an update of the media content stored thereon. Desirably in such an arrangement, the memory device is lockable within the media player such that any inadvertent removal of the memory device is minimised. Typically each media player will have an associated memory device removal tool that on interface with the media player will enable a removal of the memory device from the media player.

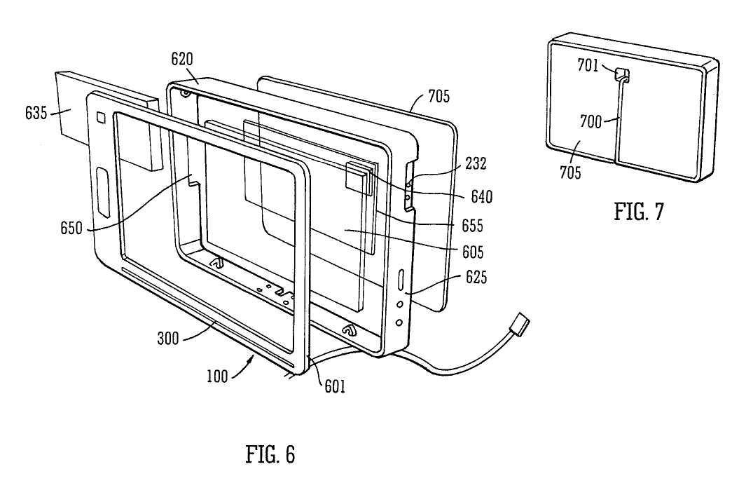

FIG. 6 shows in exploded form a media player 100 incorporating such a removal memory device. The media player is provided as a plurality of sub assemblies, each being mateable with one another to form the integrated final assembly of the media player unit. As shown in FIG. 6 a front screen assembly 600 provides a frame 601 within which a screen 605, such as an LCD screen—may be retained. The screen is presented to the frame 601 from the rear and when the frame is then seated against a chassis 620 the screen 605 will be secured between each of the chassis and the frame.

The chassis is desirably moulded from a plastics material and includes apertures 625, such as headphone jacks or game controller inputs, on side walls 630 thereof where access may be provided to internal electronics housed within the chassis.

To enable the media player to be useable without electronic coupling to a remote data source the media player 100 is provided with its own data storage unit. In the exemplary arrangement shown the data storage unit 635 is removable from the chassis of the media player. In this way the media content provided by the media player may be updated by simply replacing the data storage unit 635 with another storage unit. Desirably the storage unit is in the form of a hard drive which may be swopped in and out of electronic interface with a processor 640 provided within the chassis. Depending on the user preference the processor provides interface commands to the data storage unit to enable access to the media stored thereon for subsequent display on the LCD screen 605.

The data storage unit 635 is desirably receivable into an interior portion of the chassis through for example an aperture 650 provided in a side wall of the chassis. In a preferred arrangement the mounting mechanism for the data storage unit requires use of a separate tool to effect disengagement of the removable data storage unit from the chassis. In this way inadvertent or unauthorised removal can be obviated.

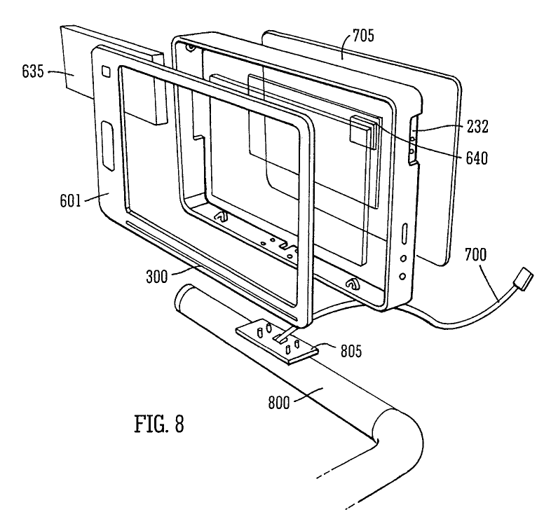

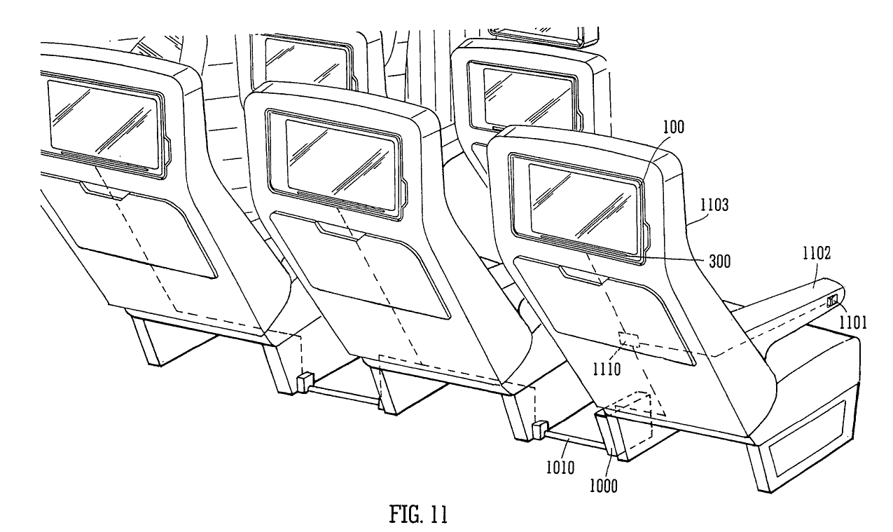

Power for such media devices could be provided by a power cabling arrangement 700 such as that shown in FIG. 7 coupled to a seat power box (seat box 1000 in FIG. 10) such as that provided by Astronics and previously referenced above. The cabling is desirably delivered into the chassis through an aperture 701 provided in a rear surface 705 of the chassis. As shown in FIG. 10 power is fed through a centralised power line 1010 to individual seats. As will be appreciated by those skilled in the art power seat boxes 1000 conventionally can be used to provide power to a plurality of seats from the same box, i.e. not each seat requires a dedicated seat box 1000. These power line bundles could also be used to carry control signals for effecting specific actions at the individual media players—as will be discussed later.

FIG. 8 shows another mounting arrangement for a media device provided in accordance with the present teaching. In this arrangement the media device 100 is configured to be mounted on a folding arm 800 which is receivable into the seat arm of a passenger seat. The arm includes a coupling arrangement 805 which is configured to be tamper proof in that possibility of disengagement of the media player from the arm 800 by a passenger is minimised whereas a technician with a suitable tool may effect removal—in a manner similar to that described with reference to removal from a seat back or bulkhead.

In a first arrangement the data storage unit is updated by authorised members of the cabin staff at periodic periods. In another arrangement responsibility for supply of the media may be given to the passengers. To enable such an implementation, the passenger will present a removable memory or data storage unit in the form of for example a USB key or the like to the media player and the media content stored thereon may then be displayed. Such an implementation will desirably be facilitated by a centralised distribution of such media storage items. This could for example be achieved in an in-flight environment such that the passenger could purchase specific media content by obtaining an appropriate data storage unit from a member of the cabin staff and then effect a playing of that content by interfacing that media storage unit with the media player. In another configuration one or more kiosks could be made available at the boarding gates or within the airport environment and the user could select their viewing preference by purchase of an appropriate memory device for transportation on to the aircraft.

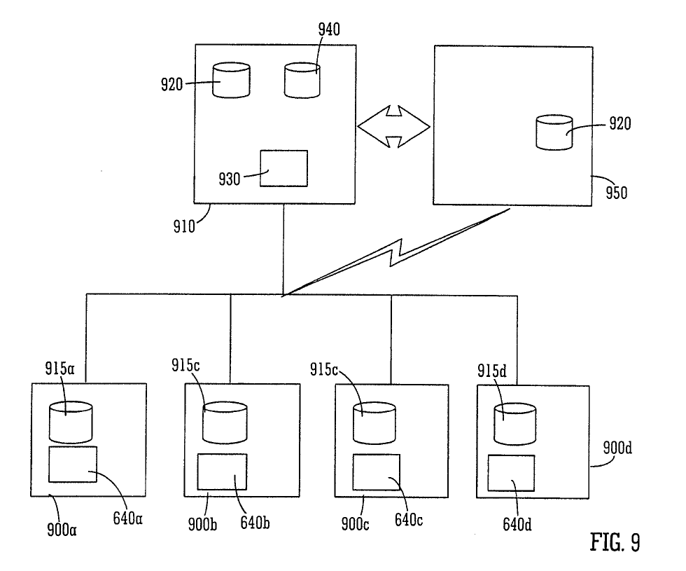

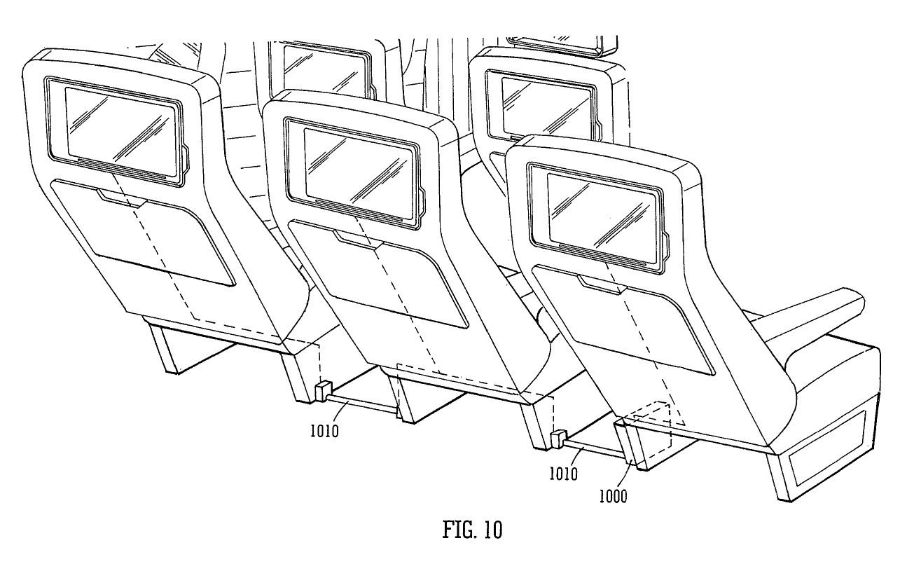

In a further modification shown in schematic form in FIG. 9 specific data files could be centrally stored within the aircraft and then distributed as required to individual media players. In this schematic network layout, a plurality of individual media players 900 are each coupled to a central server 910. The media players are configured to maintain within a local datastores 915 a first library of data files. The central server will provide a second library stored on a datastore 920 within the central server. This second library could be periodically updated through use of removable data storage devices—such as for example hot swappable hard drives or the like. The data within the second datastore 920 could be distributed during a flight through use of a trickle feed to the local media players where it will then stored and played on demand by a specific passenger. The use of such trickle feed is particularly advantageous where it is desired to preload content at the individual media players for subsequent availability. Specific content typically has licensing costs associated with it that are related to the time period when that content is available for passengers to view. Due to the time period required to load large amounts of data it may be difficult to ensure that all media players have that content from the outset. In accordance with the teaching of the present invention such problems may be overcome by loading the data to the individual media players in the time period leading up to the release date but restricting local access to that data until the actual release date. Such background loading is desirably effected by partitioning the datastores 915 into specific regions. Taking for example a data store having a 500 GB memory capacity; a first partition for example 300 GB could be reserved for always accessible data, a second partition for example 100 GB could be reserved for background loading and a third partition for example 100 GB could be reserved for recent uploads in the form of recent releases or the like. In such an arrangement the content that is accessible by a passenger using that media player can be defined by for example XML files that link to the specific partitions. If for example there is a new schedule that is intended for viewing on January 1, then during December the second partition would be loaded with that content. The XML or other format control files would dictate that the passenger would be able to access data from the first and third partitions. On January 1, the XML control file would change which partition was available for viewing by the user and the data in that partition would therefore be immediately available for viewing. By associating individual content files with identifiers it is possible using centrally provided commands to enable or disable that content for viewing at specific periods.

In an alternative arrangement any playing of the data from that second datastore will require direct access to the data at the central server 910 in that the data is streamed within the aircraft cabin.

The central server 910 is one example of a central location that may be used to transfer commands to the plurality of media players. Typically such a central server is not provided within an easily accessible location within the aircraft cabin. Other centralised locations could also be used to generate and or transmit commands to the individual media players. For example as shown in FIG. 9, a cabin interface module 950 accessible for example by flight crew or attendants, is also representative of a centralised location within the aircraft that may be used to communicate with a plurality of media players distributed about the cabin at a plurality of remote locations. The cabin interface module may effect the communication with the media players through a routing of a communication through the central server 910. Alternatively it may effect a direct communication with the media players over for example a wireless communication network provided within the aircraft cabin. In a further arrangement the cabin interface module may be coupled onto the power transmission bundle and may be configured to use that bundle to transfer commands to the individual ones of the media players.

By providing the storage of the media content at the point of display the need for complicated cabling arrangements is minimised. It will be appreciated that the streaming of high quality audio visual data to multiple destinations at user selected times requires high capacity bandwidth within the cabling and also efficient processors at a centralised hub. The other sort of data that is traditionally distributed to passenger seats is in-flight information as to for example the location of the aircraft in its flight plan or announcements relating to the progress of the flight. These are traditionally streamed concurrently to multiple seats and require less bandwidth. To enable the continued provision of such information while at the same time reducing the requirement for cabling between the individual seats and a centralised data store, each of the media players may be provided with a wireless communication module 655 which is configured to communicate with a centralised broadcast system provided as part of a communication module 930 within the aircraft central server architecture over wireless communication protocols such as 802.11 a/b/g/m.

The processor 640 could be configured that on receipt of a command signal from a central server that the media content being played from the media player devices would be temporarily disabled to allow for a viewing of the central broadcast. In this way important in-flight information could be relayed to each passenger. This command signal could be send wirelessly within the cabin or could be sent over the power line bundles that are provided to each seat but heretofore have been used only for power transmission as opposed to data transmission to control media players at the seat.

The processor 640 could also be configured such that on receipt of specific command signals that predetermined media content from the storage device could be retrieved and displayed. In this way a library of media content could be stored locally at each media player and activated/deactivated by the receipt of command signals.

One particularly advantageous use of decoupling the storage of the audiovisual content from the command signals is that the detail provided within the displayed content can be improved beyond what is traditionally available. Persons familiar for example with the moving map that is commonly available one long distance flights will be aware that the level of detail shown on that map is low. The reason for this is that this moving map is traditionally generated centrally within the aircraft cabin and then streamed to each point of display. To ensure that each seat can access this date concurrently the size of data stream is reduced to a minimum. While the map is perfectly adequate to give a general indication of the approximate location it is not possible for a user to interrogate the map. However in accordance with this exemplary arrangement of the present teaching such interrogation is possible. By having the library for the map stored locally within the media player it is possible to increase the level of detail that is viewable. In accordance with this exemplary embodiment all that is streamed to the seat are command signals pertaining to limited information such as actual height, speed, GPS locations etc. On receipt of these command signals, the processor is configured to display the correct map for those locations from the local library.

As the map is locally stored, it is possible to provide the user with user interrogation of the map. In this way a user could select a zoom function to zoom in and out of the displayed imagery. It is also possible within such teaching to enable a provision of additional information pertaining to the destinations etc than traditionally have been possible. By using interaction between the user and the displayed imagery it is possible to generate a dynamic responsive display. For example a user may select a specific geographic location and then select additional information for that location. Such information could be for example hotel information, attractions etc. The opportunity for third parties to provide their information on-flight could also be used to generate revenue for either the airplane operator or the provider of the media content if the two are separate.

It will be appreciated that in a modification to this two way interaction between a user and the map that the user could be facilitated through on-board communications to select appropriate destinations of interest and to make contact with those destinations during the flight. By having a personalised map display it is possible for the user to interrogate the map to a user specific degree, select an appropriate destination and then to effect generation of a communication to that destination for example to perfect a reservation or the like. With on-board external communications such as email, SMS and the like becoming available, it will be appreciated that a media player such as that provided in accordance with the present teaching could interface with other communication systems on board the aircraft to enable the user to send messages off the aircraft using the media player as the message generator.

It is also possible using such localised storage of predetermined libraries that are implemented by externally provided command signals to enable a local storage of predetermined cabin broadcasts. For example it is known at the start of any flight that specific cabin safety messages are required. These are typically broadcast in both audio and visual form. Using the teaching of the present invention, the generation of a command signal from a central location could effect initiation of display of specific library content at each of the media players. This could be used to generate for example the safety broadcast messages. One advantage of locally storing the broadcast and simply displaying that on receipt of an external command is that the variety of that local broadcast could be improved and the displayed image could be accompanied for example by a user selected subtitle in a language of their choice.

It will be appreciated that such an arrangement of an in-flight entertainment effects control of features of a plurality of media players that are distributed throughout an aircraft cabin through a transmission of control signals from a central hub within the cabin to the individual media players. Such control signals could be provided as wireless control signals in that they are transmitted through one or more wireless communication protocols within the aircraft cabin. In another arrangement the control signals are transmitted over the power lines that are provided to each media player. This data is desirably pushed to the media players from the central hub 910 within the aircraft. The data can be unique data which is generated specifically for that transmission or could be predefined command signals which are stored within a library 940 within the central hub and distributed to the media players as appropriate. On receipt of a predefined command signal the media player will effect a retrieval of a predefined media file and effect a local playing of that for the user.

The use of command signals that are centrally transmitted to a plurality of media players whereupon local retrieval of specific datafiles is effected may be advantageously employed to provide higher detail information to passengers than heretofore possible. For example, as was discussed above, traditionally in a moving map display all information is transmitted from the central hub to the point of display. This requires the concurrent transmission within the aircraft of graphic files, geographic location and the like. By separating out the imagery of the graphic files from the real time information of the geographic location, it is possible to provide higher detail information in the graphic files.

The command signals may also be used to effect simultaneous generation of language specific safety demonstrations. It will be appreciated that traditionally an aircraft records and displays the required safety demonstrations in a first language—that being the language of the aircraft carrier. By providing localised storage of the data files relevant to the safety demonstrations at the point of display, it is possible to provide additional features such as subtitles in different languages or indeed the provision of different language audio files for the same graphic files. By using command signals that are centrally distributed the synchronisation between the image and the audio/subtitle can be controlled. Indeed this synchronisation can be used for other content files that require concurrent display at a plurality of media players. While the media players store the content files locally through use of the interface between the individual media players and the centralised location, command signals can be used to synchronise the retrieval and display of the same content on a plurality of media players in a virtual broadcast mode.

It will be recalled that one additional problem with conventional in-flight entertainment systems is related to the powering of personal electronic equipment at the seat. In an embodiment of the present teaching shown in schematic form in FIG. 11, such problems are addressed. It will be recalled that it is known to provide power to individual seats. Such was described with reference to FIG. 10, where the exemplary arrangement of an Astronics™ seat box 1000 was described. While such systems are known to provide at seat power for example through the user of a power outlet 1101 at the seat arm 1102 of a seat 1103, traditionally the control of the power has been managed by a central master control unit that is remotely located from the seat. In accordance with this embodiment of the present teaching control of the power available at an individual seat is effected at that seat by the user. By providing a switch or other electronic control circuitry 1110 between the seat power box 1000 and the power outlet 1101 it is possible to control the availability of power to that outlet 1101. It will be appreciated that such control circuitry is shown schematically as being separate from the seat box 1000 but it could be incorporated within the seat box as well.

In a preferred arrangement the control circuitry 1110 will incorporate a switch or a relay that is provided in a normally inactive state. The control of that switch is provided to the passenger at that seat so as to provide a passenger centric control arrangement. By having the switch in a normally inactive state, in this way power will typically not be available. The user desiring power at their seat can activate the power through interaction with their personal media player 100. This activation may require a payment using for example the credit card swipe 300 that was discussed previously with regard to other applications. On receipt of an activation signal the control circuitry 1110 will switch to an active state and allow the feed of power to the outlet. This active state could be provided for an indefinite time period or could be configured to allow only for specific duration power before requiring a second command signal to effect continuance of that availability. In this way power to the individual seats will be managed, in that only those users requiring power will effect the necessary action to make that power available. Furthermore the media player could be configured to interact with a central power management system to ascertain prior to effecting an activation of a switch whether sufficient capacity is available on-board for an additional power connector to be enabled. If not, then this could be advised to the passenger requesting the power through the use for example of an on-screen message. By use of centrally provided control signals from within the cabin, override signals could be provided to each of the media players having power activated to either activate or deactivate that power as appropriate.

It will be appreciated that what has been described herein are exemplary arrangements of an in-flight entertainment system. Such a system provides a plurality of media players that may be distributed about an aircraft cabin. The individual media players are each provided with their own content that is locally stored at the respective media players. Such content can be retrieved and displayed at the media player through interaction by a passenger with the media player. While each of the media players can therefore be considered capable of operating in standalone or isolated mode, they are centrally controllable from a centralised location within an aircraft cabin. In this way the cabin staff can interface with the individual media players remotely and modify the content that is displayed on the media players—be that for example the temporary disablement of the media player or the replacement of the passenger selected content with other content. In this way airline regulations relating to required safety notices etc may be provided as desired by the airline. Such regulations require that the use of a public address system within the aircraft cabin will not be ignored by usage of an in-flight entertainment system. By use of command signals sent to each of the media players, the Public Address (PA) interrupt safety notices and PA override notices can be provided irrespective of the fact that the media content that is played locally at each player is stored locally at that player.

It will be appreciated that features of an in-flight entertainment system provided in accordance with the present teaching have been described with reference to exemplary embodiments. Where features or aspect of such an entertainment system have been described or referenced to any one Figure it will be appreciated that it is not intended to limit the teaching to that exemplary arrangement. One or more aspects of the present teaching could be used in combination with or isolation from other aspects without departing from the spirit and or scope of the present teaching. To this end it will be appreciated that what has been described herein is to assist the person skilled in the art in an understanding of the many benefits and teaching of the present invention but modifications can be made to that described without departing from the scope of the claims which are appended.

The words comprises/comprising when used in this specification are to specify the presence of stated features, integers, steps or components but does not preclude the presence or addition of one or more other features, integers, steps, components or groups thereof.

1. An in-flight entertainment system for use in an aircraft cabin, the system comprising a plurality of individual media players distributed about the cabin, individual ones of the plurality of media players having a library of content files and being configured to effect, on selection by a passenger, retrieval and display of audio visual content from the library for that passenger, the media player being further centrally controllable from a single location within the cabin.

2. The system of claim 1 wherein the individual media players are responsive to a signal transmitted to the media players from the single location within the cabin.

3. The system of claim 1 wherein the library for each media player is provided on a data storage unit for that media player, the data storage unit being coupled to the media player through an interface accessible from an external surface of the media player.

4. The system of claim 3 wherein the data storage unit is removable so as to enable an updating of the media content stored on that data storage unit.

5. The system of claim 3 wherein the data storage unit is provided in the form of a removable hard drive or other memory device that may be coupled to the media player.

6. The system of claim 3 wherein the media player includes a locking arrangement whereby the data storage unit is lockable to the media player.

7. The system of claim 6 wherein the locking arrangement requires mechanical interaction by a separate tool to effect removal of the data storage unit from the media player.

8. The system of claim 6 wherein the locking arrangement is controlled through an electronic lock.

9. The system of claim 1 being configured for wireless communication within the aircraft cabin.

10. The system of claim 1 including a power coupler for coupling the media player to an at seat power device.

11. The system of claim 10 including a secondary power outlet provided at individual passenger seats for operably providing power to one or more passenger provided electronic devices.

12. The system of claim 11 comprising control circuitry for controlling availability of power through the secondary outlet, the control circuitry being activated through user interaction with the media player.

13. The system of claim 2 wherein the signal is transmitted to individual media players using a wireless communication protocol.

14. The system of claim 2 wherein the signal is transmitted to individual media players over a power line bundle provided within the aircraft cabin.

15. The system of claim 2 wherein the media player is configured, on receipt of the signal, to display specific content from the library.

16. The system of claim 15 wherein the media player is configured to effect an update of the displayed content being displayed on the media player on receipt of the signal.

17. The system of claim 16 wherein the media player is configured to process the signal received to ascertain appropriate update from the library for subsequent display.

18. The system of claim 1 wherein the media player is configured on receipt of specific signals to temporarily disable and/or terminate the display selected by the passenger.

19. The system of claim 1 wherein the media players are fixable to furniture provided within the aircraft cabin.

20. The system of claim 1 wherein individual media players are seatable within individual chassis permanently fixed within the aircraft cabin, the chassis being dimensioned to receive the media player therein.

21. The system of claim 20 wherein the media player is lockable within the chassis such that removal of the media player requires use of a separate tool.

22. The system of claim 1 comprising a central server in communication with the plurality of media players, the central server comprising a plurality of datafiles for distribution to individual ones of the plurality of media players, the plurality of datafiles being stored on a removable data storage device.

23. The system of claim 2 wherein the signal transmitted from the single location includes real-time geographic data pertaining to the position of the aircraft, receipt of that geographic data at the media players effecting a combination of that geographic data with appropriate locally stored image files and a display of that combined image file and geographic data locally at the media player.

24. An in-flight entertainment system for use in an aircraft cabin, the system comprising:
a plurality of individual media players distributed about the cabin, individual ones of the plurality of media players having a library of content files and being configured to effect, on selection by a passenger, retrieval and display of audio visual content from the library for that passenger,
a central server in communication with the plurality of media players, the central server being configured to transmit signals to individual ones of the plurality of media players, and
wherein on receipt of signals transmitted by the central server, the individual media players are configured to modify the displayed audiovisual content being displayed.
